(19) United States
(12) Patent Application Publication
(10) Pub. No.: US 2012/0290590 A1
(43) Pub. Date: Nov. 15, 2012

(54) CONSTRUCTING A PROJECTION FOR STORING DATA

(76) Inventors: Charles Edward BEAR, Hudson, MA (US); Changjian Sun, Nashua, NH (US); Andrew Allinson Lamb, Boston, MA (US)

(21) Appl. No.: 13/469,625

(22) Filed: May 11, 2012

Related U.S. Application Data
(60) Provisional application No. 61/485,797, filed on May 13, 2011.

(51) Int. Cl. G06F 17/30

(52) U.S. Cl. 707/752; 707/736; 707/E17.044; 707/E17.014

(57) ABSTRACT

A method for constructing a projection for storing data on a storage device may include causing a processor to extract characteristics of expected output of a query on the data, and to construct a projection for the data based on the extracted characteristics.

### CROSS REFERENCE

The present non-provisional patent application claims priority from U.S. Provisional Patent Application Ser. No. US 61/485,797, filed on May 13, 2011, which is included herein by reference.

### BACKGROUND

Modern database analytic tools often perform operations on a large amount of data stored in a data warehouse. To carry out a data analysis task, a typical data loading process includes defining tables which represent a logical design of the data, and designing the physical layout of the data, commonly referred to as the “data projection.” The data is then transformed/loaded based on the logical design and physical layout. The design of the physical layout of data is critical to the database performance, but it can be a challenging task to database users.

### BRIEF DESCRIPTION OF THE DRAWINGS

Examples are described in the following detailed description and illustrated in the accompanying drawings in which:

FIG. 1 illustrates a flow diagram of a process for construction of a data projection according to examples;

FIG. 2 illustrates a flow diagram of a data loading process 200 incorporating construction of a data projection, in accordance with an example; and

FIG. 3 illustrates a system for construction of a data projection according to examples.

### DETAILED DESCRIPTION

Although examples are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “generating”, “constructing|, “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

As used in the present specification and in the appended claims, the term “data processing device” is meant to be understood broadly as any device that processes data. Examples of data processing devices include a programmable processor, a computer, a system on a chip, an analytic database, a relational database, a non-relational database, a structured database, a stream processing system, an in-memory database, a key-value database, and combinations thereof. In one example, the data processing device includes special purpose logic circuitry, such as, for example, a field programmable gate array (FPGA) of application-specific integrated circuit (ASIC).

The data processing device includes hardware or a combination of hardware and code that creates an execution environment for a computer program used in connection with the data processing device. In one example, the computer program used in connection with the data processing device is code that constitutes processor firmware, a protocol stack, a database management system, an operating system, a cross-platform runtime environment, a virtual machine, or combinations thereof. The data processing device and the execution environment created by the data processing device comprise a number of different computing model infrastructures such as, for example, web services, distributed computing, grid computing infrastructures, and combinations thereof. The data processing system may or may not have persistent storage of the data, and may be a distributed as well as a non-distributed system.

Data representation has significance both to the human user and to the data processing device. While a human user looks for a logical representation of the data, which would allow that user to logically organize data and refer to that data, the physical representation of that data affects the ease of saving, updating and retrieving that data on a storage device.

According to examples, a data table may stored arranged in columns rather than in rows. This way each column does not have all of the data associated with a single record of the data base. Instead each column includes all of the data in the table which relates to a specific data attribute across the entire table.

Each table may have one or more projections (physical data layout) which contain all or a collection of columns from that table.

In accordance with an example, data projection construction may be incorporated in a data loading process. By means of the projection construction, the physical model of data in table to be analyzed is decoupled from the table definition (logical data structure). The projection construction may be automatically performed when data is loaded into the table. The design of the physical layout, including data sort order, encoding, segmentation, etc., can be transparent to the users and can be optimized to match the input data stream, thereby maximizing performance. Automatic projection construction in accordance with examples allows the user to focus more on the data which is to be loaded and on logical relations, instead of on the physical layout design.

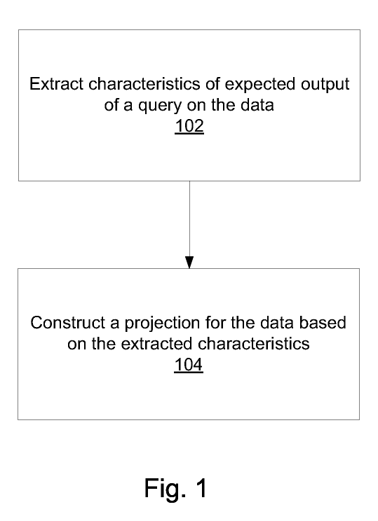

FIG. 1 illustrates a flow diagram of a process 100 for construction of a data projection according to examples.

Process 100 may include causing a processor to extract 102 characteristics of expected output of a query on the data. Process 100 may also include causing the processor to construct 104 a projection for the data based on the extracted characteristics.

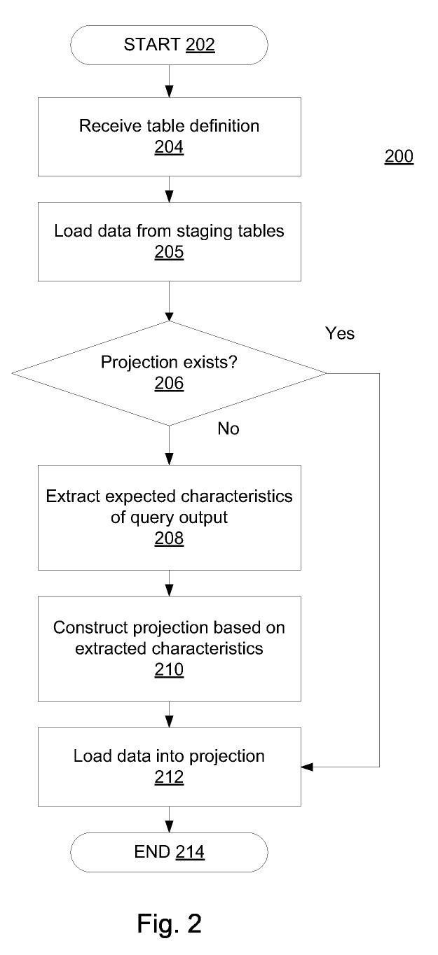

FIG. 2 illustrates a flow diagram of a data loading process 200 incorporating construction of a data projection, in accordance with an example.

Process 200 starts 202 by receiving 204 a data table definition. The user may define a table, for example, by using a “CREATE TABLE” statement. The logical relations of the data (e.g., table name, column name and column type, table and column constraints) may be defined by the user in a catalog. Since the physical layout is decoupled from the table definition, the table may not have any projection at this point.

Next, the user may issue an “INSERT SELECT” statement (e.g., INSERT INTO dest_table SELECT . . .) to load 204 data from one or a plurality of staging tables. The input query on the staging table often transforms the staging data by, for example, selecting only certain columns, joining data from multiple source tables, aggregations, etc.

Next, data is loaded 205 from staging tables. Then, it may be determined 106 whether a projection exists 206 for the loaded data.

If a projection for the table has already been designed (e.g., manually), the data will be loaded 212 into that projection, skipping automatic projection designing and ending 214 the process. If, however, the table does not have any projection, a query optimizer process may be invoked to plan the input query. First, expected characteristic of the query output are extracted 208. Expected characteristics of a query output may include, for instance, whether any column is encoded with Run-Length-Encoding (RLE), whether the output is sorted based on any columns, whether the output is distributed on multiple segmentations, etc. The projection may then be constructed 210, relating to the extracted expected characteristics, by selecting matching characteristics for the projection, such as, for example, matching sort order, column encoding, and segmentation. If data redundancy is required, parallel or “buddy” projections may also be created.

The input query may then be executed, and data is loaded 212 into the automatically constructed projection, ending 214 the process.

In this regard, automatic projection construction, in accordance with examples, in effect optimizes the loading process, avoiding data re-sorting, due to the preservation of the data sort order. It also avoids network transfer or re-segmentation, because the target projection has the same segmentation as that of the input data. Furthermore, it allows native operations on encoded data without decoding.

Overall, the automatic projection design offers multiple benefits. It provides just-in-time projection design at data loading, and can be completely transparent to the user. It enables the physical layout to be intelligently designed to match the input data stream, thereby maximizing the loading performance. The native column encoding can be inherited for improved query performance and storage compression. It meets the system data redundancy requirement. It also has the flexibility to accept manually designed (e.g., by the user) projections.

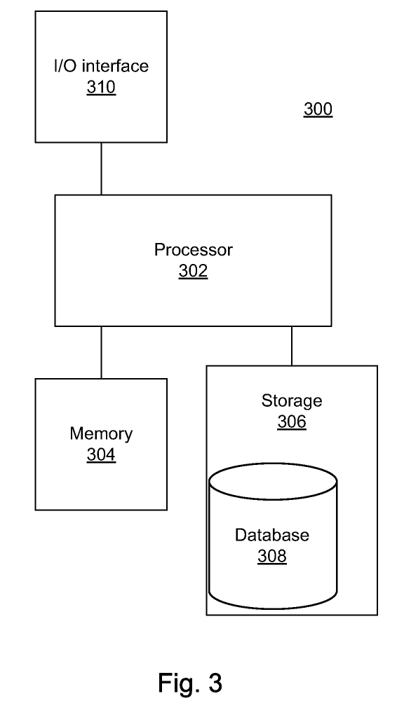

FIG. 3 illustrates a system 300 for automatic construction of a data projection according to examples.

System 300 may include a processor 302, for processing information and for executing computer program instructions. Processor 502 may be configured to execute queries. According to examples, processor 302 may be configured to automatically construct a data projection. The data may be saved in the form of database columns 308 (or any other form) on storage device 306. Storage device 306 may comprise one or a plurality of hard disks, flesh memory or any other non-transitory computer readable medium. Storage device 306 may also store a program or a plurality of computer instructions or programs in accordance with examples. Storage device 306 may be part of the system or be a part of a remote system. It may communicated with the processor directly or through a mediator, e.g. over a network (such as, for example, the Internet, intranet or other network).

Processor 302 may communicate and cooperate with volatile memory 304.

Input/Output (I/O) interface 310 may be provided for allowing a user to input information or instructions and for outputting results or other information. I/O interface 310 may be used for interfacing with other devices for getting input from such devices or for outputting information to such devices.

Examples may be embodied in the form of a system, a method or a computer program product. Similarly, examples may be embodied as hardware, software or a combination of both. Examples may be embodied as a computer program product saved on one or more non-transitory computer readable medium (or mediums) in the form of computer readable program code embodied thereon. Such non-transitory computer readable medium may include instructions that when executed cause a processor to execute method steps in accordance with examples. In some examples the instructions stores on the computer readable medium may be in the form of an installed application and in the form of an installation package.

Such instructions may be for example loaded into one or more processors and executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer, or on a plurality of computers.

Examples are described hereinabove with reference to flowcharts and/or block diagrams depicting methods, systems and computer program products according to examples.

What is claimed is:

1. A method for constructing a projection for storing data on a storage device, the method comprising:
causing a processor to:
extract characteristics of expected output of a query on the data; and
construct a projection for the data based on the extracted characteristics.

2. The method of claim 1, further comprising causing the processor to:
receive a table definition for the data; and
load the data from one or a plurality of staging tables.

3. The method of claim 1, further comprising causing the processor to load the data into the constructed projection.

4. The method of claim 1, wherein the extracted characteristics include sort order, column encoding, and segmentation.

5. The method of claim 1, further comprising causing the processor to skip the steps of extracting the characteristics and constructing the projection if a manually constructed projection for the data exists.

6. The method of claim 1, further comprising causing the processor to construct parallel data projections if data redundancy is desired.

7. A non-transitory computer readable medium having stored thereon instructions for loading data for a query, which when executed by a processor cause the processor to perform a method of:
receiving a table definition for the data;
loading the data;
if the table does not have an existing projection, extracting characteristics of expected output of a query on the data; and
constructing a projection for the data based on the extracted characteristics.

8. The non-transitory computer readable medium of claim 7, wherein the extracted characteristics include sort order, column encoding, and segmentation.

9. The non-transitory computer readable medium of claim 7, the method further comprising causing the processor to skip the steps of extracting the characteristics and constructing the projection if a manually constructed projection for the data exists.

10. The non-transitory computer readable medium of claim 7, the method further comprising causing the processor to construct parallel data projections if data redundancy is desired.

11. A system for constructing a projection for storing data on a storage device, the system comprising a processor to:
extract characteristics of expected output of a query on the data; and
construct a projection for the data based on the extracted characteristics.

12. The system of claim 11, the processor further configured to:
receive a table definition for the data; and
load the data from one or a plurality of staging tables.

13. The system of claim 11, the processor further configured to load the data into the constructed projection.

14. The system of claim 11, wherein the extracted characteristics include sort order, column encoding, and segmentation.

15. The system of claim 11, the processor further configured to skip the steps of extracting the characteristics and constructing the projection if a manually constructed projection for the data exists.

16. The system of claim 11, the processor further configured to construct parallel data projections if data redundancy is desired.

17. The system of claim 11 further comprising the storage device.
